(19) United States
(12) Patent Application Publication
(10) Pub. No.: US 2018/0123162 A1
(43) Pub. Date: May 3, 2018

(54) Second Battery, and Method of Manufacturing Secondary Battery

(71) Applicant: Hitachi, Ltd., Tokyo (JP)

(72) Inventors: Yusuke KAGA, Tokyo (JP); Kazuaki NAOE, Tokyo (JP); Shimpei AMASAKI, Tokyo (JP); Masashi NISHIKI, Tokyo (JP); Makoto ABE, Tokyo (JP); Etsuko NISHIMURA, Tokyo (JP); Akihiko NOIE, Tokyo (JP)

(21) Appl. No.: 15/797,334

(22) Filed: Oct. 30, 2017

(30) Foreign Application Priority Data
Oct. 31, 2016 (JP) 2016-212549

(51) Int. Cl. H01M 10/04; H01M 10/0525; H01M 10/0565; H01M 2/02; H01M 2/14

(52) U.S. Cl. CPC H01M 10/0468; H01M 10/0525; H01M 2300/0065; H01M 2/0277; H01M 2/14; H01M 10/0565

(57) ABSTRACT

Provided is a secondary battery having high utilization efficiency per unit volume. The secondary battery includes: an electrode laminate in which a positive electrode layer and a negative electrode layer are laminated on each other through intermediation of an insulating layer; a pair of support plates configured to sandwich the electrode laminate therebetween; and a column body which is sandwiched between the pair of support plates at both ends thereof and adhered to the pair of support plates.

### CLAIM OF PRIORITY

This application claims the priority based on the Japanese Patent Application No. 2016-212549 filed on Oct. 31, 2016. The entire contents of which are incorporated herein by reference for all purpose.

### BACKGROUND OF THE INVENTION

The present invention relates to a secondary battery and a method of manufacturing a secondary battery.

A technology related to a lithium ion secondary battery module is disclosed in Japanese Patent Laid-open Publication No. 2016-85895. In paragraph [0016] of this literature, there is a description that “A lithium ion secondary battery module 100 according to the present invention includes: a laminate 14 of a plurality of prismatic lithium ion secondary batteries (cells) 1; a pair of support plates 2a and 2b configured to sandwich the laminate 14 therebetween; a support bar 13 configured to fix the pair of support plates 2a and 2b; and a fixing member 12 and a spring 3 arranged at an end portion of the support bar 13. One end of the support bar 13 is fixed to one of the support plates (2b), and the other end of the support bar 13 is inserted into the other support plate (2a, press plate) and the fixing member 12 is fixed thereto. The spring 3 is fixed between the support plate 2a and the fixing member 12.” In addition, in paragraph [0019], there is a description that “It is preferred that at least four springs 3 be arranged on each of a pair of sides of the support plate.” In addition, in paragraph [0023], there is a description that “The fixing member 12 is preferably a fastening member (for example, a screw).”

In the lithium ion secondary battery module described in Japanese Patent Laid-open Publication No. 2016-85895, the fixing member is arranged on the outer side of the support plate, which is configured to sandwich the laminate, through intermediation of the spring, and hence a dead space having a height of the fixing member is formed. As a result, energy efficiency of the entire secondary battery per unit volume is reduced.

### SUMMARY OF THE INVENTION

The present invention has been made in view of the foregoing, and an object of the present invention is to provide a secondary battery having high utilization efficiency per unit volume.

This application includes a plurality of means for solving at least part of the above-mentioned problem, and an example of the plurality of means is as follows.

In order to solve the above-mentioned problem, a secondary battery according to one embodiment of the present invention includes: an electrode laminate in which a positive electrode layer and a negative electrode layer are laminated on each other through intermediation of an insulating layer; a pair of support plates configured to sandwich the electrode laminate therebetween; and a column body which is sandwiched between the pair of support plates at both ends thereof and adhered to the pair of support plates.

According to the present invention, the secondary battery having high utilization efficiency per unit volume can be provided.

Objects, configurations, and effects other than those described above become more apparent from the following descriptions of embodiments.

### BRIEF DESCRIPTION OF THE DRAWINGS

FIG. 1 is a schematic view for illustrating an example of a secondary battery in a first embodiment.

FIG. 2 is a schematic view for illustrating an example of an electrode laminate.

FIG. 3 is a schematic view for illustrating a modified example of the secondary battery in the first embodiment.

FIG. 4 is a schematic view for illustrating an example of a secondary battery in a second embodiment.

FIG. 5 is a view for illustrating an example of a sectional surface of a recessed member.

FIG. 6 is a view for illustrating an example of a sectional surface of a projected member.

### DESCRIPTION OF THE EMBODIMENTS

### First Embodiment

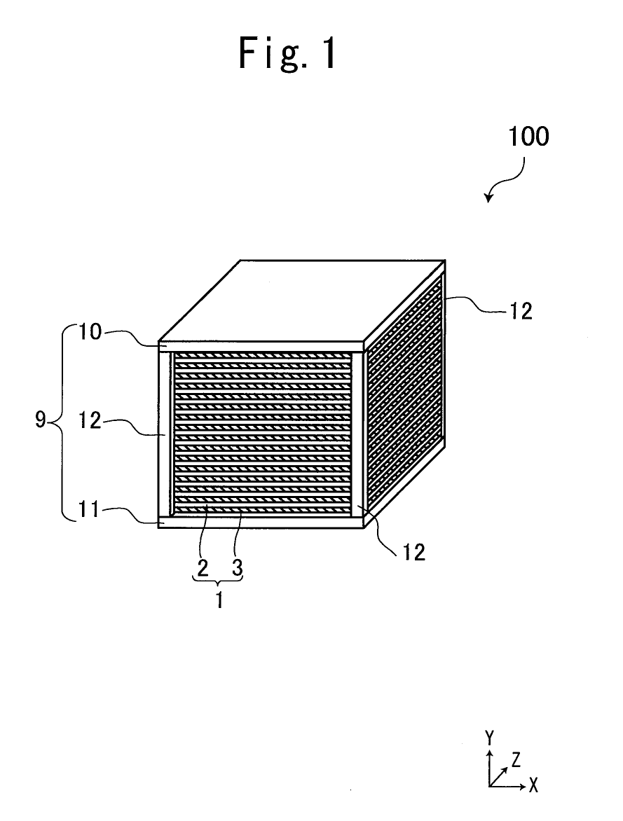

Now, an example of an embodiment of the present invention is described with reference to the drawings. In the drawings, hatching may be omitted even in a sectional view so that a configuration is clearly shown. FIG. 1 is a schematic view for illustrating an example of a secondary battery 100 in a first embodiment. The secondary battery 100 includes an electrode laminate 1, a pair of support plates (a support plate 10 and a support plate 11), and a column body 12. The electrode laminate 1 is held by an electrode laminate holding structure 9 formed of the support plates 10 and 11, and the column body 12.

Materials of the support plates 10 and 11 are not limited as long as the materials have high heat resistance, but the support plates 10 and 11 are each formed of, for example, a resin or a metal. For example, stainless steel, a phenol resin, a melamine resin, an epoxy resin, a silicone resin, an unsaturated polyester resin, or a diallyl phthalate resin may be used for the support plates 10 and 11. The support plates 10 and 11 each have a shape of, for example, a thin plate having a rectangular bottom surface, and each desirably have a thickness (in the Y direction in FIG. 1) of 0.5 mm or more and 10 mm or less, a length (in the Z direction in FIG. 1) of 50 mm or more and 1,020 mm or less, and a width (in the X direction in FIG. 1) of 50 mm or more and 1,020 mm or less.

The column body 12 is formed of a thermoplastic resin. For example, a vinyl-based resin, a polystyrene-based resin, a polypropylene resin, a polyacetal resin, a polyacrylic resin, a polyamide-based resin, or a fluorine-based resin may be used for the column body 12. The column body 12 has a shape of, for example, a rectangular column or a circular column, and desirably has a height (in the Y direction in FIG. 1) of 0.035 mm or more and 400 mm or less, and a bottom surface area of 20 mm² or more and 20,000 mm² or less. The column bodies 12 are arranged at least at four corners of the support plates 10 and 11.

Both ends of the column body 12 in a longitudinal direction are adhered to the support plate 10 and the support plate 11. The adhering of both ends of the column body 12 to the support plate 10 and the support plate 11 is performed, for example, by laser welding, with an adhesive, or by ultrasonic welding.

The electrode laminate 1 is a laminate including a positive electrode 2 and a negative electrode 3, and their details are described below.

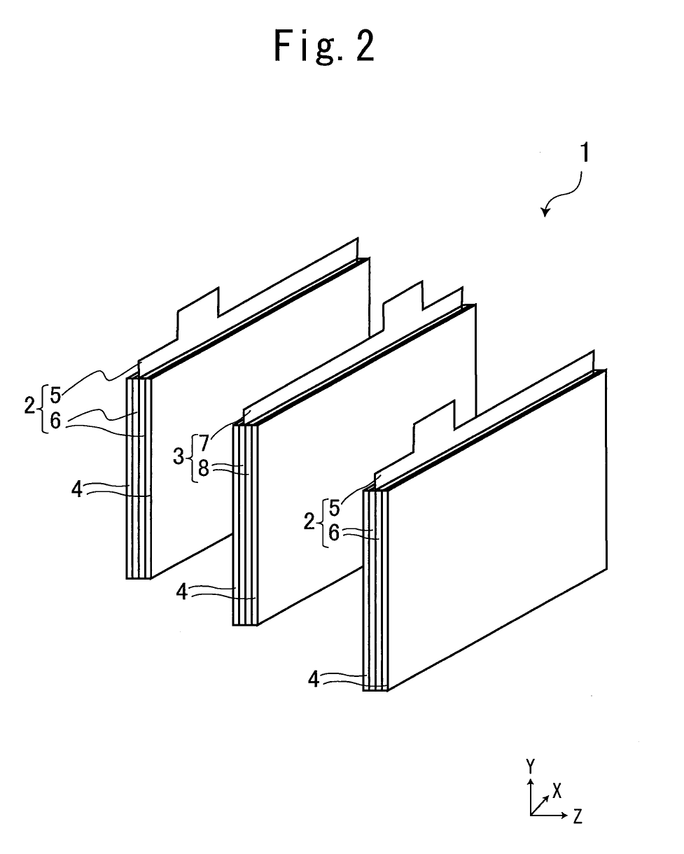

FIG. 2 is a schematic view for illustrating an example of the electrode laminate 1. In the electrode laminate 1, the positive electrode 2 and the negative electrode 3 are alternately laminated through intermediation of an insulating layer. Needless to say, the numbers of the positive electrodes 2 and the negative electrodes 3 constituting the electrode laminate 1 are not limited to the numbers illustrated in FIG. 2.

First, description is given of the positive electrode 2. The positive electrode 2 includes a positive electrode collector foil 5 and a positive electrode application layer 6. The positive electrode collector foil 5 is a metal foil, and for example, stainless steel or aluminum may be used. The positive electrode collector foil 5 desirably has a thickness of 5 μm or more and 20 μm or less.

The positive electrode application layer 6 is formed through use of a positive electrode mixture. The positive electrode mixture contains a positive electrode active material, a binder, a conductive assistant, and a semi-solid electrolyte. The positive electrode active material may be any material which allows intercalation and deintercalation of lithium. For example, a lithium-containing transition metal oxide obtained by preliminarily incorporating a sufficient amount of lithium into an elemental transition metal, such as Mn, Ni, Co, or Fe, or into two or more kinds of such transition metals may be used as the positive electrode active material.

In addition, also the crystal structure of the positive electrode active material is not particularly limited. The crystal structure may be any structure which allows intercalation and deintercalation of lithium ions, such as a spinel crystal structure or a layered crystal structure. In addition, the positive electrode active material may be formed through use of a material obtained by replacing part of a transition metal or lithium in a crystal with an element such as Fe, Co, Ni, Cr, Al, or Mg, or a material obtained by doping an element such as Fe, Co, Ni, Cr, Al, or Mg in the crystal.

There are no particular limitations on the binder, and for example, polyvinyl fluoride, polyvinylidene fluoride, polytetrafluoroethylene, or a polyvinylidene fluoride-hexafluoropropylene copolymer may be used. A carbon material is used as the conductive assistant. For example, acetylene black, Ketjen black, artificial graphite, or a carbon nanotube may be used as the conductive assistant.

The semi-solid electrolyte contains an electrolytic solution and a carrier configured to adsorb the electrolytic solution on its surface. When the secondary battery 100 is a lithium ion battery, the use of an aqueous electrolytic solution causes lithium to react with water to generate a hydrogen gas. Therefore, a non-aqueous electrolytic solution is desirably used as the electrolytic solution.

A lithium salt, such as (CF₃SO₂)₂NLi, (SO₂F)₂NLi, LiPF₆, LiClO₄, LiAsF₆, LiBF₄, LiB (C₆H₅)₄, CH₃SO₃Li, or CF₃SO₃Li, or a mixture thereof may be used as the electrolytic solution.

In addition, in the electrolytic solution, an organic solvent, such as tetraethylene glycol dimethyl ether, triethylene glycol dimethyl ether, ethylene carbonate, dimethyl carbonate, ethyl methyl carbonate, propylene carbonate, diethyl carbonate, 1,2-dimethoxyethane, 1,2-diethoxyethane, γ-butyrolactone, tetrahydrofuran, 1,3-dioxolane, 4-methyl-1,3-dioxolane, diethyl ether, sulfolane, methylsulfolane, acetonitrile, or propionitrile, or a mixed liquid thereof may be used as a solvent.

Silicon dioxide, aluminum oxide, titanium dioxide, zirconium oxide, polypropylene, or polyethylene, or a mixture thereof may be used as the carrier. It is desired that the carrier have a large surface area per unit volume in order to increase the amount of the electrolytic solution to be adsorbed. Accordingly, fine particles each having a small particle diameter are desired as the carrier.

A material of the carrier is not limited thereto. The carrier may be one having properties of the conductive assistant.

An example of a method of forming the positive electrode application layer 6 is as described below. The positive electrode active material, the conductive assistant (doubling as the carrier described above), the binder, and the electrolytic solution are mixed, and the mixture is dispersed in a dispersion solvent, such as N-methyl-2-pyrrolidone (NMP), to thereby produce a positive electrode slurry. The positive electrode slurry is applied onto both surfaces of the positive electrode collector foil 5, and heated (at, for example, 120° C. or less). Thus, the positive electrode slurry on the positive electrode collector foil 5 is dried.

The temperature to be used for the heating is a temperature at which the electrolytic solution is not decomposed. After that, an application film of the dried positive electrode slurry is subjected to press compression. Thus, the positive electrode application layer 6 can be obtained. The thickness of the positive electrode application layer 6 may be appropriately changed depending on a capacity. The positive electrode application layer 6 desirably has a thickness of 10 μm or more and 200 μm or less.

Next, description is given of a semi-solid electrolyte layer 4. The semi-solid electrolyte layer 4 functions as an insulating layer configured to insulate the positive electrode 2 and the negative electrode 3 from each other to prevent their electrical contact, and also functions as a spacer configured to allow lithium ions to pass therethrough. The semi-solid electrolyte layer 4 is in a gel form (including a semi-solid state, a solid state, and a quasi-solid state), and is formed on the surfaces of the positive electrode 2 and the negative electrode 3. The semi-solid electrolyte layer 4 desirably has a thickness of 5 μm or more and 30 μm or less.

The semi-solid electrolyte layer 4 is formed through use of a material containing a semi-solid electrolyte and a binder. The semi-solid electrolyte contains an electrolytic solution and a carrier as with the semi-solid electrolyte of the positive electrode application layer 6 described above, and materials similar to those of the semi-solid electrolyte of the positive electrode application layer 6 may be used. Although particles each having properties of the conductive assistant may be used as the carrier in the semi-solid electrolyte of the positive electrode application layer 6, a material having properties of the conductive assistant cannot be used in the semi-solid electrolyte layer 4, which is an insulating layer.

The binder is not particularly limited, and for example, polyvinyl fluoride, polyvinylidene fluoride (PVDF), polytetrafluoroethylene, polyimide, styrene-butadiene rubber, or a polyvinylidene fluoride-hexafluoropropylene copolymer, or a mixture thereof may be used.

An example of a method of forming the semi-solid electrolyte layer 4 is as described below. The electrolytic solution, the carrier, and the binder are mixed, and the mixture is dispersed in a dispersion solvent, such as N-methyl-2-pyrrolidone (NMP), to thereby produce a semi-solid electrolyte slurry. The semi-solid electrolyte slurry is applied onto the positive electrode application layer 6, and heated with a drying furnace (at, for example, 120° C. or less) to be dried. The temperature to be used for the heating is a temperature at which the electrolytic solution is not decomposed. Thus, the semi-solid electrolyte layer 4 can be formed on the positive electrode 2.

The method of forming the semi-solid electrolyte layer 4 is not limited thereto. For example, it is appropriate to form the semi-solid electrolyte layer 4 as a self-supporting film and then laminate the film on the positive electrode application layer 6.

The positive electrode 2 having formed on both surfaces thereof the semi-solid electrolyte layers 4 is punched into an arbitrary size. The positive electrode 2 having formed thereon the semi-solid electrolyte layers 4 desirably has a width (in the X direction in FIG. 2) of 50 mm or more and 1,000 mm or less and a height (in the Y direction in FIG. 2) of 50 mm or more and 1,000 mm or less.

Next, description is given of the negative electrode 3. The negative electrode 3 includes a negative electrode collector foil 7 and a negative electrode application layer 8 applied onto the negative electrode collector foil 7. The negative electrode collector foil 7 is a metal foil, and for example, stainless steel or copper may be used. The negative electrode collector foil 7 desirably has a thickness of 5 μm or more and 20 μm or less.

The negative electrode application layer 8 is formed by applying a negative electrode mixture onto both surfaces of the negative electrode collector foil 7. The negative electrode mixture contains a negative electrode active material, a binder, a conductive assistant, and a semi-solid electrolyte. A material of the negative electrode active material is not limited, but for example, a crystalline or non-crystalline carbon material, or a carbon material such as natural graphite, a graphite agent, or coke may be used.

Also its particle form in the negative electrode application layer 8 is not limited, and for example, materials of various particle forms, such as a flake form, a spherical form, a fibrous form, and an aggregate form, may be used.

The binder is not particularly limited, and for example, polyvinyl fluoride, polyvinylidene fluoride, polytetrafluoroethylene, or a polyvinylidene fluoride-hexafluoropropylene copolymer may be used. A carbon material is used for the conductive assistant. For example, acetylene black, Ketjen black, artificial graphite, or a carbon nanotube may be used as the conductive assistant. The semi-solid electrolyte is similar to the semi-solid electrolyte to be used in the positive electrode application layer 6, and hence the description thereof is omitted.

An example of a method of forming the negative electrode application layer 8 is as described below. The negative electrode active material, the conductive assistant (doubling as the carrier in the semi-solid electrolyte), the binder, and the electrolytic solution are mixed, and the mixture is dispersed in a dispersion solvent, such as N-methyl-2-pyrrolidone (NMP), to thereby produce a negative electrode slurry. The negative electrode slurry is applied onto the negative electrode collector foil 7, and heated (at, for example, 120° C. or less). Thus, the negative electrode slurry on the negative electrode collector foil 7 is dried.

The temperature to be used for the heating is a temperature at which the electrolytic solution is not decomposed. After that, an application film of the dried negative electrode slurry is subjected to press compression. Thus, the negative electrode application layer 8 can be obtained. The thickness of the negative electrode application layer 8 may be appropriately changed depending on a capacity. The negative electrode application layer 8 desirably has a thickness of 10 μm or more and 200 μm or less.

After that, the semi-solid electrolyte layer 4 is formed on the negative electrode 3. The formation method is similar to the method of forming the semi-solid electrolyte layer 4 on the positive electrode 2. The negative electrode 3 having formed thereon the semi-solid electrolyte layers 4 is punched into an arbitrary size. The negative electrode 3 having formed thereon the semi-solid electrolyte layers 4 desirably has a width of 50 mm or more and 1,000 mm or less and a height of 50 mm or more and 1,000 mm or less.

As described above, the electrode laminate 1 is obtained by alternately laminating the positive electrode 2 and the negative electrode 3 through intermediation of the insulating layer (semi-solid electrolyte layer 4). The electrode laminate 1 desirably has a thickness of 0.035 mm or more and 400 mm or less.

In this embodiment, the semi-solid electrolyte layer 4 is laminated on each of the positive electrode 2 and the negative electrode 3, but a lamination method is not limited thereto. The positive electrode 2 and the negative electrode 3 only need to be laminated on each other through intermediation of the semi-solid electrolyte layer 4.

In this embodiment, the electrode laminate 1 is obtained through use of the positive electrode 2 and the negative electrode 3 (lamination step). After that, the electrode laminate 1 and the column body 12 at both ends thereof are sandwiched between the support plate 10 and the support plate 11 (sandwiching step). At this time, both the ends of the column body 12 are adhered to the support plates 10 and 11.

Next, the secondary battery 100 is heated through at least one of the support plate 10 or the support plate 11 (heating step), and the support plate 10 or the support plate 11 is pressed against the other. That is, at least one of the support plate 10 or the support plate 11 is pressed so that the support plate 10 is pressed in the −y direction in FIG. 1 or the support plate 11 is pressed in the +y direction in FIG. 1. With this, the column body 12 deforms to contract in a height direction. The heating step is performed at a temperature equal to or higher than the softening point of the column body 12.

After that, the secondary battery 100 is cooled (cooling step), and thus the column body 12 is hardened while maintaining its contraction state. After the cooling step, the pressing of the support plate 10 or the support plate 11 is stopped. With this, gaps in the electrode laminate 1 and gaps between the electrode laminate 1 and the support plates 10 and 11 are reduced as compared to those before the pressing, and the electrode laminate 1 is tightly bound.

In the secondary battery 100 including a lithium ion battery, gaps caused by peeling of the collector foil or gaps between particles constituting an electrode layer contribute to high resistance. Particularly when a material containing an electrolyte having less flowability is used, the electrolyte cannot be expected to flow into the gaps, and there is a risk in that battery performance may be reduced.

According to this embodiment, the pair of support plates 10 and 11 are fixed under a state of being pressed against each other through the contraction of the column body 12, and hence a reduction in electrical performance due to the gaps can be suppressed. In addition, the secondary battery 100 is improved in utilization efficiency per unit volume as compared to, for example, a secondary battery in which a column body penetrates through a support plate so that an end of the column body may protrude out of the support plate, because no member protrudes out of the support plates 10 and 11. In addition, when an insulating resin is used for the column body 12, shortage between the electrodes can be prevented even in the case where the electrode laminate 1 is brought into contact with the column body 12.

While the column body 12 is formed of the thermoplastic resin in this embodiment, the configuration of the column body 12 is not limited thereto. The column body 12 may be formed of any material which contracts depending on conditions. For example, a thermosetting resin or an ultraviolet curable resin may be used for the column body 12. When a material has high flowability and the column body 12 cannot retain its shape before being hardened, it is appropriate to form the column body 12 by impregnating the material of the column body 12 in a porous substance, such as polyurethane.

### Modified Example

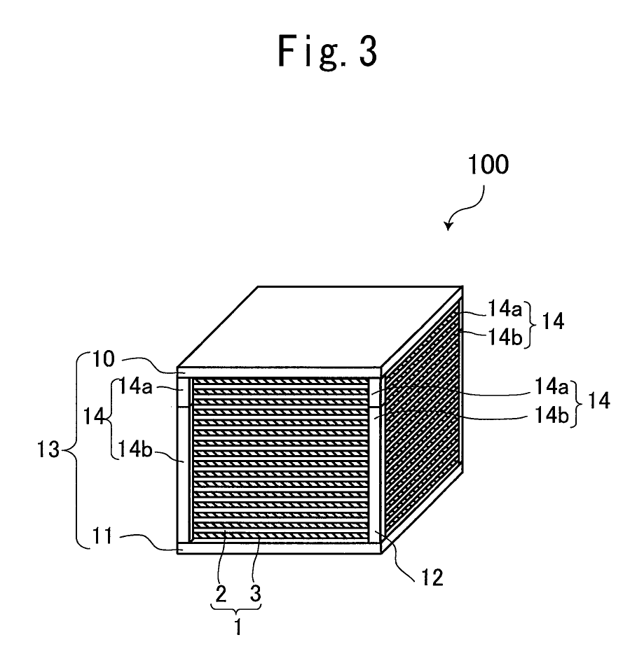

FIG. 3 is a schematic view for illustrating a modified example of the secondary battery 100 in the first embodiment. A column body 14 in this modified example differs from the column body in the above-mentioned embodiment in that the column body 14 includes a contraction part 14a and a main body part 14b. An electrode laminate holding structure 13 is formed of the support plates 10 and 11 and the column body 14.

The contraction part 14a is formed of a material which softens depending on conditions. The contraction part 14a is formed of, for example, a thermoplastic resin. The main body part 14b is formed of a material which does not soften under the softening conditions of the contraction part 14a. The main body part 14b is formed of, for example, a resin having high heat resistance.

When the column body 14 at both ends thereof and the electrode laminate 1 are sandwiched between the support plate 10 and the support plate 11 and pressing is performed under contraction conditions, the contraction part 14a softens. After that, the contraction part 14a is hardened. Thus, the electrode laminate 1 is tightly bound under a state in which gaps in the secondary battery 100 are reduced.

According to this modified example, the secondary battery 100 in which no member protrudes over an external surface and which has high utilization efficiency per unit volume as compared to a secondary battery in which a member protrudes can be provided. In addition, a reduction in electrical performance due to the gaps can be suppressed because the support plates 10 and 11 are fixed under a state of being pressed against each other.

### Second Embodiment

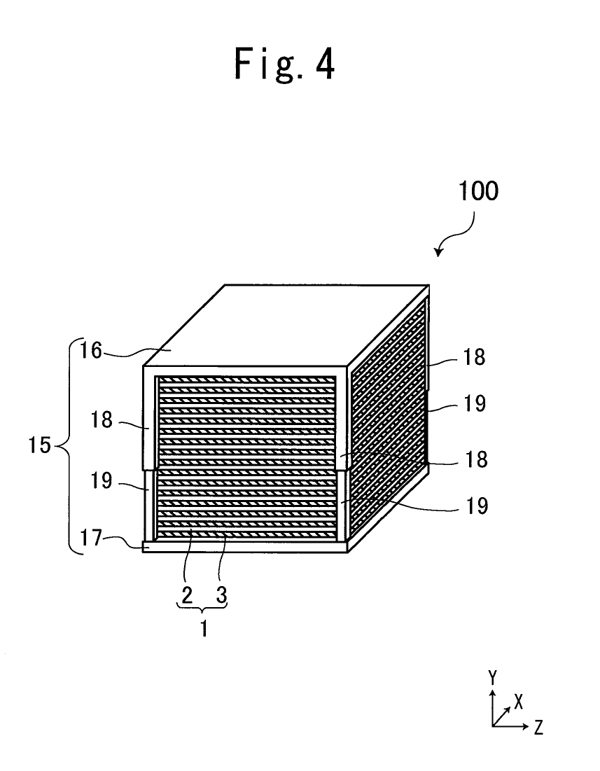

FIG. 4 is a schematic view for illustrating an example of a secondary battery 100 in a second embodiment. A column body in this embodiment differs from those in the above-mentioned embodiments in that the column body includes a recessed member 18 and a projected member 19, and the recessed member 18 and the projected member 19 include a locking mechanism configured to lock the support plates so that the support plates are prevented from moving in a direction away from each other. The difference from the above-mentioned embodiments is described below.

An electrode laminate 1 is sandwiched between a sandwiching member 16 and a sandwiching member 17. The sandwiching member 16 includes a support plate and a plurality of recessed members 18.

The sandwiching member 17 includes a support plate and a plurality of projected members 19. The recessed member 18 and the projected member 19 make a pair to function as a column body. That is, it can be said that the support plate constituting the sandwiching member 16 and the support plate constituting the sandwiching member 17 make a pair to sandwich a column body formed of the recessed member 18 and the projected member 19 at both end thereof.

In addition, the recessed member 18 and the support plate, and the projected member 19 and the support plate may be formed integrally, or may be a combination of separately formed components. That is, it can be said that one end of the column body (on a recessed member 18 side) is adhered to the support plate, and the other end of the column body (on a projected member 19 side) is adhered to the support plate.

The recessed member 18 is a member of a hollow shape including a hollow portion which is encompassed in a sectional surface perpendicular to a longitudinal direction. The projected member 19 is a member formed so as to fit in the hollow portion of the recessed member 18. The recessed member 18 and the projected member 19 are each formed of, for example, a resin or a metal.

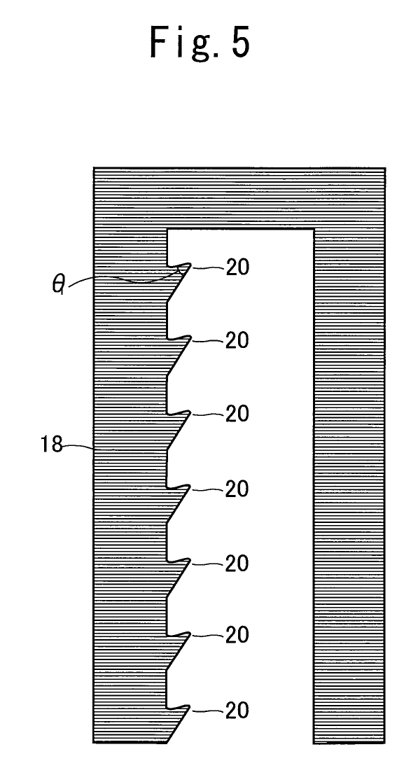

FIG. 5 is a view for illustrating an example of a sectional surface of the recessed member 18. FIG. 5 is a sectional view of the recessed member 18 in a state of being cut in a direction parallel to the longitudinal direction. The recessed member 18 includes a protrusion portion 20 in its inside. The protrusion portion 20 protrudes in an obliquely upper right direction in FIG. 5 so that the protrusion portion 20 having engaged with a recess portion of the projected member 19 described later is prevented from disengaging from the recess portion. The protrusion angle θ₁ of the protrusion portion 20 in the sectional surface is, for example, an acute angle.

That is, the protrusion portion 20 functions as the locking mechanism configured to lock the support plate of the sandwiching member 16 and the support plate of the sandwiching member 17 so that these support plates are prevented from moving in a direction away from each other (so that the sandwiching member 16 is prevented from moving in the +y direction in FIG. 4 and the sandwiching member 17 is prevented from moving in the −y direction in FIG. 4).

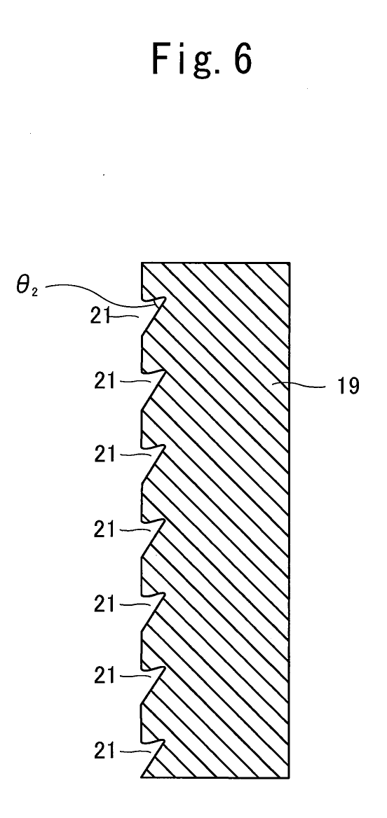

FIG. 6 is a view for illustrating an example of a sectional surface of the projected member 19. FIG. 6 is a sectional view of the projected member 19 in a state of being cut in a direction parallel to the longitudinal direction. The projected member 19 includes a recess portion 21 in its inside. The protrusion portion 20 of the recessed member 18 engages with the recess portion 21. The recess portion 21 cuts in an obliquely upper right direction in FIG. 6 so that the protrusion portion 20 having engaged therewith is kept in the engaged state. The cut angle θ₂ of the recess portion 21 is, for example, an acute angle.

That is, the recess portion 21 functions as the locking mechanism configured to lock the support plate of the sandwiching member 16 and the support plate of the sandwiching member 17 so that these support plates are prevented from moving in a direction away from each other (so that the sandwiching member 16 is prevented from moving in the +y direction in FIG. 4 and the sandwiching member 17 is prevented from moving in the −y direction in FIG. 4).

In FIG. 5 and FIG. 6, the recessed member 18 includes the protrusion portion 20 and the projected member 19 includes the recess portion 21. However, a configuration in which the recessed member 18 includes the recess portion 21 and the projected member 19 includes the protrusion portion 20 may be adopted. In addition, in FIG. 5 and FIG. 6, the recessed member 18 and the projected member 19 include a plurality of protrusion portions 20 and a plurality of recess portions 21, respectively, but the numbers of the protrusion portions 20 and the recess portions 21 are not limited thereto.

In this embodiment, an electrode laminate holding structure 15 is formed by, for example, superimposing the electrode laminate 1 on the sandwiching member 17, and superimposing the sandwiching member 16 on the sandwiching member 17 while aligning the position of the recessed member 18 of the sandwiching member 16 with the position of the projected member 19 of the sandwiching member 17. At least one of the sandwiching member 16 or the sandwiching member 17 is pressed against the other (the sandwiching member 16 is pressed in the −y direction in FIG. 4 or the sandwiching member 17 is pressed in the +y direction in FIG. 4).

That is, the projected member 19 fits in the hollow portion of the recessed member 18 to form the column body. At this time, the protrusion portion 20 and the recess portion 21 are engaged with each other under the state in which the electrode laminate 1 is sandwiched between the sandwiching members 16 and 17. After that, the pressing is stopped. Through the engagement of the protrusion portion 20 and the recess portion 21, the sandwiching members 16 and 17 are fixed under the state of tightly binding the electrode laminate 1.

According to this embodiment, even when heating is not performed, the electrode laminate 1 can be tightly bound without causing an end of the column body or other members to protrude over an external surface of the support plate. Accordingly, the utilization efficiency of the secondary battery 100 per unit volume can be improved.

The above-mentioned embodiments are described by taking a lithium ion battery as an example, but the embodiments of the present invention are not limited to the lithium ion battery, and various changes may be made without departing from the gist of the present invention. For example, the present invention is applicable to power storage devices (for example, other secondary batteries and a capacitor) each including a positive electrode, a negative electrode, and a separator configured to electrically separate the positive electrode and the negative electrode from each other.

The examples and modified examples of the embodiments according to the present invention have been described, but the present invention is not limited to these examples of the embodiments described above and encompasses various modified examples. For example, the examples of the embodiments described above are described in detail for a better understanding of the present invention, and the present invention is not limited to one having the entire configuration described above. In addition, part of the configuration of an example of an embodiment may be replaced with the configuration of another example. In addition, the configuration of an example of an embodiment may be added to the configuration of another example. In addition, for part of the configuration of an example of each embodiment, another configuration may be added, removed, or replaced.

What is claimed is:

1. A secondary battery, comprising:
an electrode laminate in which a positive electrode layer and a negative electrode layer are laminated on each other through intermediation of an insulating layer;
a pair of support plates configured to sandwich the electrode laminate therebetween; and
a column body which is sandwiched between the pair of support plates at both ends thereof and adhered to the pair of support plates.

2. A secondary battery according to claim 1, wherein at least part of the column body is formed of a thermally deformable resin.

3. A secondary battery according to claim 1, wherein at least part of the column body is formed of a thermoplastic resin.

4. A secondary battery according to claim 1, wherein:
the pair of support plates each have a rectangular shape parallel to the respective layers constituting the electrode laminate; and
the column bodies are arranged at least at four corners of the pair of support plates.

5. A secondary battery according to claim 1, wherein the column body comprises a locking mechanism configured to lock the pair of support plates so that the pair of support plates are prevented from moving in a direction away from each other.

6. A secondary battery according to claim 1, wherein:
the column body comprises a recessed member and a projected member configured to fit in the recessed member; and
one of the recessed member and the projected member has formed therein a protrusion portion, and the other member has formed therein a recess portion configured to engage with the protrusion portion.

7. A secondary battery according to claim 1, wherein the column body is formed of a material containing at least one of a vinyl-based resin, a polystyrene-based resin, a polypropylene resin, a polyacetal resin, a polyacrylic resin, a polyamide-based resin, or a fluorine-based resin.

8. A secondary battery according to claim 1, wherein the insulating layer comprises a gel electrolyte.

9. A secondary battery according to claim 1, wherein the insulating layer is formed of a material containing: a lithium salt containing at least one of (CF₃SO₂)₂NLi, (SO₂F)₂NLi, LiPF₆, LiClO₄, LiAsF₆, LiBF₄, LiB(C₆H₅)₄, CH₃SO₃Li, or CF₃SO₃Li; and a solvent containing at least one of tetraethylene glycol dimethyl ether, triethylene glycol dimethyl ether, ethylene carbonate, dimethyl carbonate, ethyl methyl carbonate, propylene carbonate, diethyl carbonate, 1,2-dimethoxyethane, 1,2-diethoxyethane, γ-butyrolactone, tetrahydrofuran, 1,3-dioxolane, 4-methyl-1,3-dioxolane, diethyl ether, sulfolane, methylsulfolane, acetonitrile, or propionitrile.

10. A method of manufacturing a secondary battery, comprising:
laminating a positive electrode layer and a negative electrode layer on each other through intermediation of an insulating layer to provide an electrode laminate;
sandwiching, between a pair of support plates, a column body at both ends thereof and the electrode laminate; and
performing heating after the sandwiching to deform the column body.
